(19) United States
(12) Patent Application Publication
(10) Pub. No.: US 2008/0220741 A1
(43) Pub. Date: Sep. 11, 2008

(54) MOBILE DEVICE, COMMUNICATION SYSTEM, AND CONNECTION ESTABLISHING METHOD

(75) Inventor: YU-CHIANG HUNG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/766,112

(22) Filed: Jun. 21, 2007

(30) Foreign Application Priority Data
Mar. 9, 2007 (CN) 200710200261.8

(51) Int. Cl. H04M 1/66; H04K 1/00

(52) U.S. Cl. 455/411; 380/247; 380/270

(57) ABSTRACT

A mobile device (100) for establishing a connection with an access point (200) includes an interface module (110), an authentication module (120), and an association module (130). The interface module receives a user authentication instruction to launch authentication. The authentication module authenticates the access point via a first service set identifier (SSID) in order to acquire a second SSID and a key from the access point when the authentication is successfully launched. The association module re-associates with the access point via the second SSID and the key. A communication system and a connection establishing method are also provided.

### BACKGROUND OF THE INVENTION

1. Field of the Invention

The present invention relates to wireless communications, and particularly to a mobile device, a communication system, and a connection establishing method.

2. Description of Related Art

With the developments of wireless voice over Internet protocol (VoIP) technologies, a dual mode phone supporting the global system for mobile communication (GSM) and the voice over wireless local area network (VoWLAN) is produced. The dual mode phone can be used for GSM and VoWLAN phone calls.

The dual mode phone needs to establish a connection with an access point within a WLAN before making VoWLAN phone calls via the access point.

Conventionally, a service set identifier (SSID) and a wired fidelity (WiFi) protected access pre-shared key (WPA-PSK) of the access point must be manually set in the dual mode phone by users in order to establish the connection between the dual mode phone and the access point. However, the manual setting is difficult for many users to perform, and commonly only suitably qualified users are able to complete the task successfully.

Overall, it can be very difficult for common users to set up the SSID and the WPA-PSK. Moreover, some users do not even know how to set up the SSID and the WPA-PSK at all.

### SUMMARY OF THE INVENTION

An exemplary embodiment of the present invention provides a mobile device that establishes a connection with an access point. The mobile device includes an interface module, an authentication module, and an association module. The interface module receives a user authentication instruction to launch authentication. The authentication module authenticates the access point via a first service set identifier (SSID) in order to acquire a second SSID and a key from the access point when the authentication is successfully launched. The association module re-associates with the access point via the second SSID and the key.

Another exemplary embodiment of the present invention provides a communication system. The communication system includes an access point and a mobile device that establishes a connection with the access point. The mobile device includes an interface module, an authentication module, and an association module. The interface module receives a user authentication instruction to launch authentication. The authentication module authenticates the access point via a first service set identifier (SSID) in order to acquire a second SSID and a key from the access point. The association module re-associates with the access point via the second SSID and the key. The access point includes a start module, an authorization module, and a communication module. The start module receives a user authorization instruction to start authorization. The authorization module authorizes the mobile device to inform of the second SSID and the key. The communication module communicates data with the mobile device via the second SSID and the key.

A further exemplary embodiment of the present invention provides a connection establishing method for establishing a connection between an access point and a mobile device. The connection establishing method includes the following steps. The access point receives a user authorization instruction to start authorization. The mobile device receives a user authentication instruction to launch authentication. The mobile device transmits a handshake request packet to the access point via a first SSID to query a second SSID and a key. The access point transmits a welcome packet with the second SSID and the key to the mobile device. The mobile device transmits an acknowledgement packet to the access point to inform that the second SSID and the key have been received. The mobile device re-associates with the access point via the second SSID and the key.

Other advantages and novel features will become more apparent from the following detailed description when taken in conjunction with the accompanying drawings, in which:

### BRIEF DESCRIPTION OF THE DRAWINGS

FIG. 1 is a schematic diagram of a communication system of an exemplary embodiment of the present invention;

FIG. 2 is a schematic diagram of functional modules of a mobile device and an access point of another exemplary embodiment of the present invention;

FIG. 3 is a flowchart of a connection establishing method of a further exemplary embodiment of the present invention;

FIG. 4 is a flowchart of details of certain initial steps shown in FIG. 3; and

FIG. 5 is a flowchart of details of the remaining steps shown in FIG. 3.

### DETAILED DESCRIPTION OF THE INVENTION

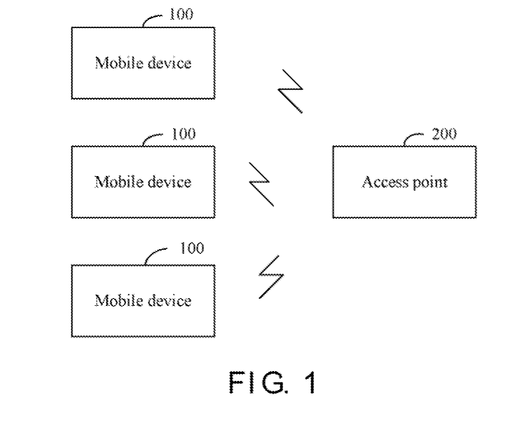

FIG. 1 is a schematic diagram of a communication system of an exemplary embodiment of the present invention. In the exemplary embodiment, the communication system includes a plurality of mobile devices 100 and an access point 200. The plurality of mobile devices 100 may be devices which can be connected to a wireless local area network (WLAN) such as dual mode phones supporting global system for mobile communication (GSM) and voice over WLAN (VoWLAN), wireless fidelity (WiFi) phones, notebook computers, personal digital assistants (PDAs), etc.

In this embodiment, the access point 20 initially receives a user authorization instruction to start authorization, and then one mobile device 100 receives a user authentication instruction to launch authentication. The mobile device 100 transmits a handshake request packet to the access point 200 via a first service set identifier (SSID) to query a second SSID and a key, and then the access point 200 transmits a welcome packet with the second SSID and the key to the mobile device 100, and then the mobile device 100 transmits an acknowledgement packet to the access point 200 to inform that the second SSID and the key have been received. Afterwards, the mobile device 100 re-associates with the access point 200 via the second SSID and the key. That is, the mobile device 100 engages in data communication with the access point 200 via the second SSID and the key.

Thus it can be seen, the access point 200 includes two SSIDs. The first SSID is used for authentication and authorization between the mobile device 100 and the access point 200, and the second SSID is used for data communication between the mobile device 100 and the access point 200. Thus, the mobile device 100 automatically and securely establishes a connection with the access point 200 via the first and second SSIDs.

For example, when the mobile device 100 is a dual mode phone, the first SSID can be used for authorization for phone groups of the access point 200, and the second SSID can be used for phone calls between the mobile device 100 and the access point 200. Accordingly, the mobile device 100 can automatically and securely join one phone group of the access point 200. In addition, when one new mobile device 100 joins one phone group of the access point 200, the authorized mobile devices 100 can maintain phone calls because different SSIDs are used.

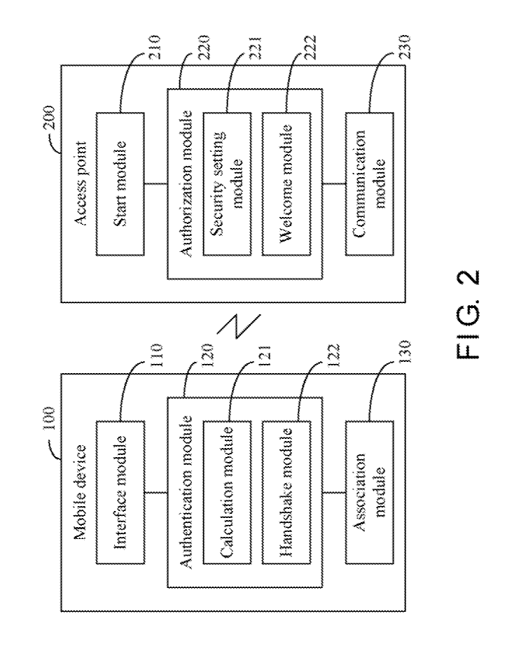

FIG. 2 is a schematic diagram of functional modules of the mobile device 100 and the access point 200 of an exemplary embodiment of the present invention.

In one aspect, the mobile device 100 includes an interface module 110, an authentication module 120, and an association module 130.

The interface module 110 receives a user authentication instruction to launch authentication. In the exemplary embodiment, the interface module 110 may be a button or another input device, and can immediately receive the user authentication instruction after being pressed by users.

For example, when the mobile device 100 is a dual mode phone, the interface module 110 can receive the user authentication instruction to launch group joining of the access point 200.

The authentication module 120 authenticates the access point 200 via a first SSID in order to acquire a second SSID and a key from the access point 200 when the authentication is successfully launched. In the exemplary embodiment, the key may be a WiFi protected access pre-shared key (WPA-PSK), a Wi-Fi protected access version 2 pre-shared key (WPA2-PSK), a wired equivalent privacy (WEP) key, etc.

The authentication module 120 includes a calculation module 121 and a handshake module 122. The calculation module 121 calculates the first SSID according to a serial number (S/N) of the access point 200. In the exemplary embodiment, the access point 200 has a unique serial number such as a manufacturer serial number. The calculation module 121 stores the serial number of the access point 200, and calculates the first SSID according to the stored serial number.

In other embodiments, if the serial number of the access point 200 is invalid, or is not stored in the calculation module 121, the calculation module 121 asks users to input the serial number of the access point 200.

The handshake module 122 transmits a handshake request packet to the access point 200 via the first SSID to query the second SSID and the key. Then the access point 20 receives the handshake request packet, and transmits the second SSID and the key to the mobile device 100.

Afterwards, the handshake module 122 receives the second SSID and the key, and transmits an acknowledgement packet to the access point 200 to inform that the second SSID and the key have been received.

The association module 130 re-associates with the access point 200 via the second SSID and the key. That is, the association module 130 enters into data communication with the access point 200 via the second SSID and the key.

In another aspect, the access point 200 includes a start module 210, an authorization module 220, and a communication module 230. The start module 210 receives a user authorization instruction to start authorization. In the exemplary embodiment, the start module 210 may be a button or another input device, and immediately receives the user authorization instruction after pressed by users.

The authorization module 220 authorizes the mobile device 100 to inform of the second SSID and the key. In the exemplary embodiment, the authorization module 220 includes a security setting module 221 and a welcome module 222.

The security setting module 221 disables and enables a security setting on the first SSID. In the exemplary embodiment, when the start module 210 starts authorization, the security setting module 221 disables the security setting on the first SSID in order that the mobile device 100 authenticates the access point 200 via the first SSID. When the mobile device 100 has been authorized via the first SSID by the access point 200, the security setting module 221 enables the security setting on the first SSID again, thereby maintaining secure communication.

The welcome module 222 transmits a welcome packet with the second SSID and the key to the mobile device 100. In the exemplary embodiment, the welcome module 222 stores the second SSID and the key. The welcome module 222 encrypts the second SSID and the key by an advanced encryption standard (AES) algorithm, and then transmits the welcome packet with the encrypted second SSID and the encrypted key to the mobile device 100. The mobile device 100 receives the welcome packet, and then decrypts the encrypted second SSID and the encrypted key to acquire the second SSID and the key by the AES algorithm.

The communication module 230 communicates data with the mobile device 100 via the second SSID and the key.

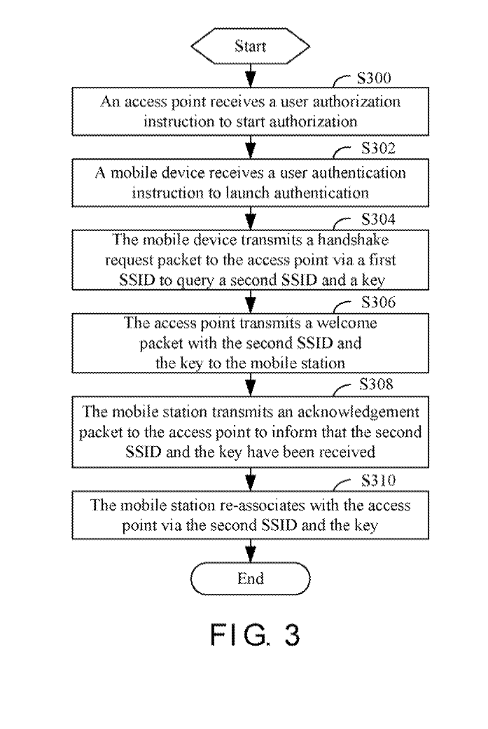

FIG. 3 is a flowchart of a connection establishing method of an exemplary embodiment of the present invention.

In step S300, the access point 200 receives a user authorization instruction to start authorization.

In step S302, the mobile device 100 receives a user authentication instruction to launch authentication.

In step S304, the mobile device 100 transmits a handshake request packet to the access point 200 via a first SSID to query a second SSID and a key.

In step S306, the access point 200 transmits a welcome packet with the second SSID and the key to the mobile device 100.

In step S308, the mobile device 100 transmits an acknowledgement packet to the access point 200 to inform that the second SSID and the key have been received.

In step S310, the mobile device 100 re-associates with the access point 200 via the second SSID and the key.

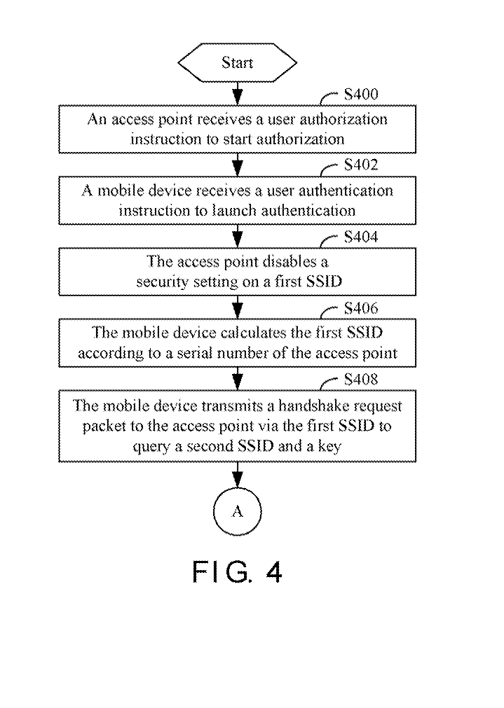

FIG. 4 is a flowchart of details of certain initial steps shown in FIG. 3, and the connection establishing method is executed via the functional modules of FIG. 2. Step 400 corresponds to step 300 shown in FIG. 3, steps 402-406 correspond to step 302 shown in FIG. 3, and step 408 corresponds to step 304 shown in FIG. 3.

In step S400, the access point 200 receives a user authorization instruction to start authorization via the start module 210. In the exemplary embodiment, the start module 210 may be a button or another input device, and immediately receives the user authorization instruction when pressed by users.

In step S402, the mobile device 100 receives a user authentication instruction to launch authentication via the interface module 110. In the exemplary embodiment, the interface module 110 may be a button or another input device, and immediately receives the user authentication instruction when pressed by users.

In step S404, the access point 200 disables a security setting on a first SSID. In this embodiment, when the access point 200 starts authorization, the security setting module 220 disables the security setting on the first SSID, in order that the mobile device 100 authenticates the access point 200 via the first SSID.

In step S406, the mobile device 100 calculates the first SSID according to a serial number of the access point 200. In the exemplary embodiment, the access point 200 has a unique serial number, such as a manufacturing serial number. The calculation module 200 stores the serial number of the access point 200, and calculates the first SSID according to the stored serial number.

In step S408, the mobile device 100 transmits a handshake request packet to the access point 200 via the first SSID to query a second SSID and a key. In this embodiment, the key may be a WPA-PSK, a WPA2-PSK, or a WEP key.

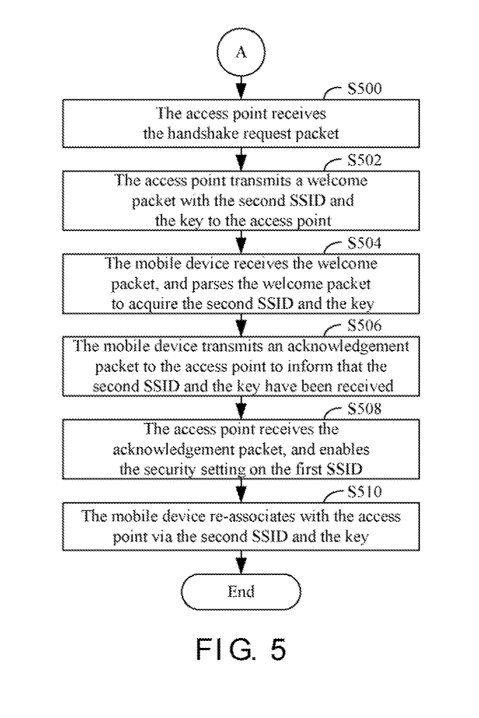

FIG. 5 is a flowchart of details of the remaining steps shown in FIG. 3. Steps 500-504 correspond to step 306 shown in FIG. 3, steps 506 and 508 correspond to step 308 shown in FIG. 3, and step 510 corresponds to step 310 shown in FIG. 3.

In step S500, the access point 200 receives the handshake request packet.

In step S502, the access point 200 transmits a welcome packet with the second SSID and the key to the mobile device 100. In the exemplary embodiment, the welcome module 222 stores the second SSID and the key, encrypts the second SSID and the key by an AES algorithm, and then transmits the welcome packet with the encrypted second SSID and the encrypted key.

In step S504, the mobile device 100 receives the welcome packet, and parses the welcome packet to acquire the second SSID and the key. In the exemplary embodiment, the handshake module 122 receives the welcome packet with the encrypted second SSID and the encrypted key, and then decrypts the encrypted second SSID and the encrypted key to acquired the second SSID and the key by the AES algorithm.

In step S506, the mobile device 100 transmits an acknowledgement packet to the access point 200 to inform that the second SSID and the key have been received.

In step S508, the access point 200 receives the acknowledgement packet, and enables the security setting on the first SSID.

In step S510, the mobile device 100 re-associates with the access point 200 via the second SSID and the key. That is, the mobile device 100 communicates data with the access point 200 via the second SSID and the key.

In the embodiment of the present invention, the access point 200 includes two SSID. The first SSID is used for authentication and authorization between the mobile device 100 and the access point 200. The second SSID is used for data communication between the mobile device 100 and the access point 200. Therefore, when one new mobile device 100 authenticates with the access point 200, the authorized mobile device 100 maintains data communication with the access point 200.

In addition, the mobile device 100 engages in data communication with the access point 200 without usage of the first SSID, namely the first SSID being hidden, which can prevent hacking by hackers trying to scan the first SSID. Accordingly secure communication is assured.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A mobile device, for establishing a connection with an access point, the mobile device comprising:
an interface module, for receiving a user authentication instruction to launch authentication;
an authentication module, for authenticating the access point via a first service set identifier (SSID) in order to acquire a second SSID and a key from the access point when the authentication is successfully launched; and
an association module, for re-associating with the access point via the second SSID and the key.

2. The mobile device as described in claim 1, wherein the mobile device is a dual-mode phone, and the interface module is for receiving the user authentication instruction to launch group joining of the access point.

3. The mobile device as described in claim 1, wherein the authentication module comprises a calculation module for calculating the first SSID according to a serial number of the access point.

4. The mobile device as described in claim 3, wherein the authentication module further comprises a handshake module for transmitting a handshake request packet to the access point via the first SSID to query the second SSID and the key.

5. The mobile device as described in claim 4, wherein the handshake is also for transmitting an acknowledgment packet to the access point to inform that the second SSID and the key have been received.

6. The mobile device as described in claim 1, wherein the key is one of the group consisting of a wired equivalent privacy (WEP) key, a Wi-Fi protected access pre-shared key (WPA-PSK), and a Wi-Fi protected access version 2 pre-shared key (WPA2-PSK).

7. A communication system, comprising:
an access point; and
a mobile device, for establishing a connection with the access point, comprising:
an interface module, for receiving a user authentication instruction to launch authentication;
an authentication module, for authenticating the access point via a first service set identifier (SSID) in order to acquire a second SSID and a key from the access point; and
an association module, for re-associating with the access point via the second SSID and the key;
wherein the access point comprises:
a start module, for receiving a user authorization instruction to start authorization;
an authorization module, for authorizing the mobile device to inform of the second SSID and the key; and
a communication module, for communicating data with the mobile device via the second SSID and the key.

8. The communication system as described in claim 7, wherein the authentication module comprises a calculation module, for calculating the first SSID according to a serial number of the access point.

9. The communication system as described in claim 8, wherein the authentication module further comprises a handshake module, for transmitting a handshake request packet to the access point via the first SSID to query the second SSID and the key.

10. The communication system as described in claim 9, wherein the authorization module comprises a welcome module, for transmitting a welcome packet with the second SSID and the key to the mobile device.

11. The communication system as described in claim 10, wherein the handshake module is also for transmitting an acknowledgement packet to the access point to inform that the second SSID and the key have been received.

12. The communication system as described in claim 7, wherein the authorization module comprises a security setting module, for disabling and enabling a security setting on the first SSID.

13. A connection establishing method, for establishing a connection between an access point and a mobile device, comprising:
receiving a user authorization instruction to start authorization by the access point;
receiving a user authentication instruction to launch authentication by the mobile device;
transmitting a handshake request packet from the mobile device to the access point via a first service set identifier (SSID) to query a second SSID and a key;
transmitting a welcome packet with the second SSID and the key from the access point to the mobile device;
transmitting an acknowledgement packet from the mobile device to the access point to inform that the second SSID and the key have been received; and
re-associating with the access point via the second SSID and the key by the mobile device.

14. The connection establishing method as described in claim 13, further comprising:
disabling a security setting on the first SSID by the access point; and
calculating the first SSID according to a serial number of the access point by the mobile device.

15. The connection establishing method as described in claim 14, further comprising:
receiving the handshake request packet from the mobile device by the access point.

16. The connection establishing method as described in claim 15, further comprising:
receiving the welcome packet from the access point, and parsing the welcome packet to acquire the second SSID and the key, both by the mobile device.

17. The connection establishing method as described in claim 16, further comprising:
receiving the acknowledgement packet from the access point, and enabling the security setting on the first SSID, both by the access point.
